(19) United States
(12) Patent Application Publication
(10) Pub. No.: US 2022/0286718 A1
(43) Pub. Date: Sep. 8, 2022

(54) METHOD FOR PLAYING BACK LIVE-STREAMING VIDEO, AND DEVICE THEREOF

(71) Applicant: BEIJING DAJIA INTERNET INFORMATION TECHNOLOGY CO., LTD., Beijing (CN)

(72) Inventor: Shengxiang FENG, Beijing (CN)

(21) Appl. No.: 17/752,434

(22) Filed: May 24, 2022

Related U.S. Application Data
(63) Continuation of application No. PCT/CN2020/131144, filed on Nov. 24, 2020.

(30) Foreign Application Priority Data
Dec. 27, 2019 (CN) 201911380761.3

(51) Int. Cl. H04N 21/2387; H04N 21/2187; H04N 19/40

(52) U.S. Cl. CPC H04N 21/2387; H04N 21/2187; H04N 19/40

(57) ABSTRACT

Provided is a method for playing back a live-streaming video. The method includes: receiving a live-stream playback request from a first client, wherein the live-stream playback request includes a video identification and a target definition; acquiring address information of target video data based on the video identification and the target definition; and sending the address information to the first client, wherein the address information is provided to the first client to acquire the target video data and play the target video data.

### CROSS-REFERENCE TO RELATED APPLICATION

This application is a continuation application of International Application No PCT/CN2020/131144, filed on Nov. 24, 2020, which claims the priority of Chinese Application No. 201911380761.3, filed on Dec. 27, 2019 both of which are incorporated by reference herein.

### TECHNICAL FIELD

The present disclosure relates to the field of live-streaming technologies, and in particular, relates to a method for playing back a live-streaming video and a device thereof.

### BACKGROUND

With developments of the live-streaming technologies and the changes in people's lifestyle, live streaming becomes more and more popular. At present, art anchor records the video while performing the live streaming, and the recorded video is stored in the live-stream source site. When a viewer wants to play back a video of the anchor, a corresponding video needs to be read from the live-stream source site and then played by a viewer client.

### SUMMARY

The present disclosure provides a method for playing back a live-streaming video, and a device thereof.

According to an aspect of embodiments of the present disclosure, a method for playing back a live-streaming video is provided. The method is performed by a server, and includes: receiving a live-stream playback request from a first client, wherein the live-stream playback request is configured to request playback of a video generated based on a live-streaming video, the live-stream playback request includes a video identification and a target definition, and the first client is a viewer client; acquiring address information of target video data based on the video identification and the target definition, wherein the target video data is video data of the live-streaming video with the video identification and the target definition; and sending the address information to the first client, wherein the address information is provided to the first client to acquire the target video data and play the target video data.

According to another aspect of embodiments of the present disclosure, a method for playing back a live-streaming video is provided. The method is performed by a first client, and includes: receiving a live-stream playback instruction for a live-streaming video, wherein the live-stream playback instruction includes a target definition; sending a live-stream playback request to a server in response to the live-stream playback instruction, wherein the live-stream playback request is configured to request playback of a video generated based on the live-streaming video, and the live-stream playback request includes a video identification and the target definition; receiving address information of target video data from the server, wherein the target video data is video data of the live-streaming video with the video identification and the target definition; acquiring the target video data based on the address information; and playing the target video data.

According to another aspect of embodiments of the present disclosure, an apparatus for playing back a live-streaming video is provided. The apparatus is applied to a server, and includes: a request receiving unit, an address information acquiring unit and an address information returning unit.

The request receiving unit is configured to receive a live-stream playback request from a first client, wherein the live-stream playback request is configured to request playback of a video generated based on a live-streaming video, the live-stream playback request includes a video identification and a target definition, and the first client is a viewer client.

The address information acquiring unit is configured to acquire address information of target video data based on the video identification and the target definition, wherein the target video data is video data of the live-streaming video with the video identification and the target definition.

The address information returning unit is configured to send the address information to the first client, wherein the address information is provided to the first client to acquire the target video data and play the target video data.

According to another aspect of embodiments of the present disclosure, an apparatus for playing back a live-streaming video is provided. The apparatus is applied to a first client, and includes: an instruction receiving unit, a request sending unit, an address receiving unit, a first video acquiring unit and a video playing unit.

The instruction receiving unit is configured to receive a live-stream playback instruction for a live-streaming video, wherein the live-stream playback instruction includes a target definition.

The request sending unit is configured to send a live-stream playback request to a server in response to the live-stream playback instruction, wherein the live-stream playback request is configured to request playback of a video generated based on the live-streaming video, and the live-stream playback request includes a video identification and the target definition.

The address receiving unit is configured to receive address information of target video data from the server, wherein the target video data is video data of the live-streaming video with the video identification and the target definition.

The first video acquiring unit is configured to acquire the target video data based on the address information.

The video playing unit is configured to play the target video data.

According to another aspect of embodiments of the present disclosure, a server is provided. The server includes a processor, and a memory configured to store one or more instructions executable by the processor; wherein the processor, when loading and executing the one or more instructions, is caused to: receive a live-stream playback request from a first client, wherein the live-stream playback request is configured to request playback of a video generated based on a live-streaming video, the live-stream playback request includes a video identification and a target definition, and the first client is a viewer client; acquire address information of target video data based on the video identification and the target definition, wherein the target video data is video data of the live-streaming video with the video identification and the target definition; and send the address information to the first client, wherein the address information is provided to the first client to acquire the target video data and play the target video data.

According to another aspect of embodiments of the present disclosure, a client is provided. The client includes a processor, and a memory configured to store one or more instructions executable by the processor; wherein the processor, when loading and executing the one or more instructions, is caused to: receive a live-stream playback instruction for a live-streaming video, wherein the live-stream playback instruction includes a target definition; send a live-stream. playback request to a server in response to the live-stream playback instruction, wherein the live-stream playback request is configured to request playback of a video generated based on the live-streaming video, and the live-stream playback request includes a video identification and the target definition; receive address information of target video data from the server, wherein the target video data is video data of the live-streaming video with the video identification and the target definition; acquire the target video data based on the address information; and play the target video data.

According to another aspect of embodiments of the present disclosure, a system for playing back a live-streaming video is provided. The system includes: a server, a first client, and at least one node of a content delivery network, which are connected with each other over network.

The at least one node of the content delivery network is configured to store candidate video data acquired by transcoding live-streaming video data.

The first client is configured to receive a live-stream playback instruction for a live-streaming video, the live-stream playback instruction including a target definition, and send the live-stream playback request to the server in response to the live-stream playback instruction, wherein the live-stream playback request is configured to request playback of a video generated based on the live-streaming video and the live-stream playback request includes a video identification and the target definition.

The server is configured to receive the live-stream playback request from the first client, acquire address information of the target video data based on the video identification and the target definition, and send the address information to the first client, wherein the target video data is video data of the live-streaming video with the video identification and the target definition.

The first client is further configured to acquire the target video data from a target node of the content delivery network among the at least one node of the content delivery network based on the address information, and play the target video data, wherein the target video data is acquired by transcoding the live-streaming video data and stored in the target node of the content delivery network.

According to another aspect of embodiments of the present disclosure, a non-volatile computer-readable storage medium storing one or more instructions therein is provided. The one or more instructions, when loaded and executed by a processor of a server, cause the server to: receive a live-stream playback request from a first client, wherein the live-stream playback request is configured to request playback of a video generated based on a live-streaming video, the live-stream playback request includes a video identification and a target definition, and the first client is a viewer client; acquire address information of target video data based on the video identification and the target definition, wherein the target video data is video data of the live-streaming video with the video identification and the target definition; and send the address information to the first client, wherein the address information is provided to the first client to acquire the target video data and play the target video data.

According to another aspect of embodiments of the present disclosure, a non-volatile computer-readable storage medium storing one or more instructions therein is provided. The one or more instructions, when loaded and executed by a processor of a first client, cause the first client to: receive a live-stream playback instruction for a live-streaming video, wherein the live-stream playback instruction includes a target definition; send a live-stream playback request to a server in response to the live-stream playback instruction, wherein the live-stream playback request is configured to request playback of a video generated based on the live-streaming video, and the live-stream playback request includes a video identification and the target definition; receive address information of target video data from the server, wherein the target video data is video data of the live-streaming video with the video identification and the target definition; acquire the target video data based on the address information; and play the target video data.

It should be understood that the above general descriptions and the following detailed descriptions are only exemplary and illustrative, which cannot limit the present disclosure.

### BRIEF DESCRIPTION OF THE DRAWINGS

The accompanying drawings, which are incorporated in and constitute a part of the description, illustrate embodiments of the present disclosure and together with the description, serve to explain the principles of the present disclosure, and do not constitute an improper limitation of the present disclosure,

FIG. 1 is a schematic diagram of an implementation environment of a method for playing back a live-streaming video according to an embodiment of the present disclosure;

FIG. 2 is a block diagram of a server according to an embodiment of the present disclosure;

FIG. 3 is a block diagram of a viewer client according to another embodiment of the present disclosure;

FIG. 4 is a flowchart of a method for playing back a live-streaming video according to an embodiment of the present disclosure;

FIG. 5 is a schematic diagram of a process for pushing live-streaming video data to a node of a content delivery network according to an embodiment of the present disclosure;

FIG. 6 is a Flowchart of a method for playing back a live-streaming video according to another embodiment of the present disclosure;

FIG. 7 is a schematic diagram of an interface for a video playback list according to an embodiment of the present disclosure;

FIG. 8 is a time sequence chart of a method for playing back a live-streaming video according to an embodiment of the present disclosure;

FIG. 9 is a block diagram of an apparatus for playing back a live-streaming video according to an embodiment of the present disclosure;

FIG. 10 is a block diagram of an apparatus for playing back a live-streaming video according to another embodiment of the present disclosure; and

FIG. 11 is a block diagram of a system for playing hack a live-streaming video according to an embodiment of the present disclosure.

### DETAILED DESCRIPTION

For better understanding of the technical solutions of the present disclosure by those of ordinary skill in the art, the technical solutions in embodiments of the present disclosure are described clearly and completely with reference to the accompanying drawings.

It is to be noted that terms “first,” “second,” and the like used in the specification, claims and the accompanying drawings are used for the purpose of distinguishing similar objects instead of indicating a particular order or sequence. It should be understood that data used in this way are interchangeable under appropriate circumstances, such that the embodiments of the present disclosure described herein can be implemented in an order other than the order illustrated or described herein. The term “at least one” in the present disclosure refers to one or more. The embodiments and practice set forth in the following descriptions of some embodiments do not represent all embodiments or practice consistent with the present disclosure. instead, they are merely examples of apparatuses and methods consistent with appended claims and the aspects related to the present disclosure.

The expression “embodiment” as mentioned in the specification indicates that a particular feature, a structure, or characteristic described in conjunction with an embodiment is included in at least one embodiment of the present disclosure. The expression occurring at various parts of the specification does not necessarily mean the same embodiment, nor is it a separate or candidate embodiment that is mutually exclusive with other embodiments. It is understood, both explicitly and implicitly, by those of ordinary skill in the art that the embodiments described herein are compatible with other embodiments.

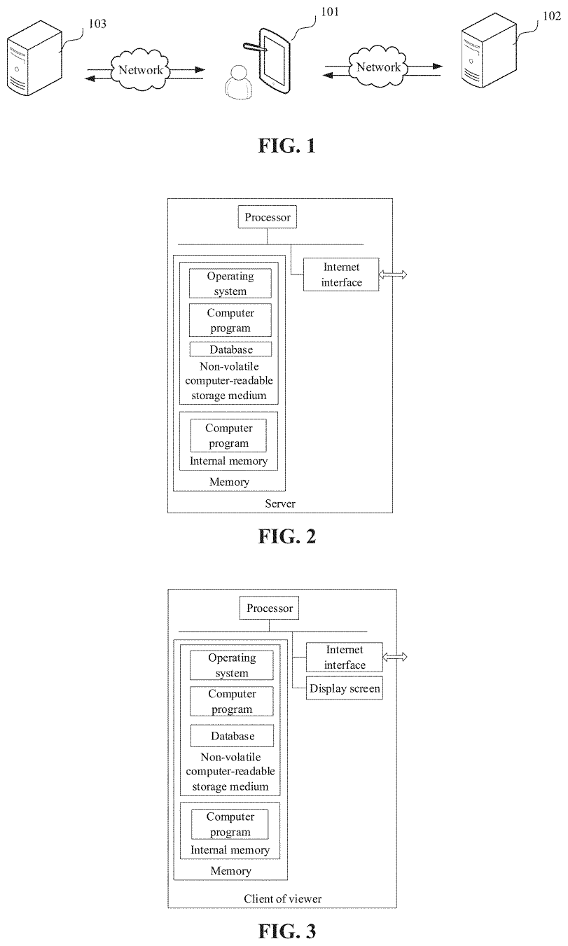

Methods for playing back a live-streaming video according to embodiments of the present disclosure are performed in an implementation environment as shown in FIG. 1. The implementation environment at least includes a first client 101 and a server 102. The first client 101 is a viewer client, and the first client 101 is connected to the server 102 over the network. The first client 101 can acquire target video data of a live-streaming video for playback from the server 102 based on a live-stream playback request, and play the target video data. The live-stream playback request includes a video identification and a target definition, wherein the target video data is video data of the live-streaming video with the video identification and the target definition.

In some embodiments, the target video data is stored in the server 102., and the first. client 101 acquires the target video data directly from the server 102. In some other embodiments, the target video data is not stored in the server 102 but a node of a content delivery network (CDN). With further reference to FIG, 1, the implementation environment further includes a target node of a CDN 103, and the first client 101, the server 102. and the target node of the CDN 103 are connected with each other over the network. The first client 101 acquires definition selection information (including the target definition) of a live-streaming video to be viewed by the user, and acquires address information of the target. video data from the server 102. based on the definition selection information. The address information herein is address information of the target video data in the target node of the CDN 103. The first client 101 acquires the target video data from the target node of the CDN 103 based on the address information.

The first client 101 includes, but is not limited to, various personal computers, laptops, srnartphones, tablets, and portable wearable devices, and the server 102 is implemented with a standalone server or a server cluster of a plurality of servers, The server 102 herein is connected with at least one first client 101 to synchronously or asynchronously respond to the live-stream playback request from the first client 101, thereby acquiring corresponding target video data. The server 102 is further connected with at least one target node of the CDN 103 to push the target video data to respective target nodes of the CDN 103.

FIG. 2 is a block diagram of a server according to an embodiment of the present disclosure. As shown in FIG. 2, the server includes: a processor, and a memory configured to store one or more instructions executable by the processor. The processor, when loading and executing the one or more instructions, is caused to perform the methods for playing back a live-streaming video according to the embodiments. In some embodiments, the server includes a processor, a memory, a network interface and the like, which are connected via a system bus. The processor is configured to provide computing and control capabilities. The memory includes a non-volatile computer-readable storage medium and an internal memory. The non-volatile computer-readable storage medium stores an operating system, a computer program (which cause the processor to perform the method for playing back a live-streaming video when run by the processor) and a database. The internal memory provides an environment for running the operating system and the computer program in the non-volatile computer-readable storage medium. The database is configured to store data involved in performing the method for playing back a live-streaming video. For example, the database is configured to store address information and the like. The network interface is configured to communicate with an external terminal via the network. For example, the network interface is configured to receive a playback instruction from the first client, and send target video data to the first client.

FIG. 3 is a block diagram of a first client according to an embodiment of the present disclosure. As shown in FIG. 3, the first client includes: a processor, and a memory configured to store one or more instructions executable by the processor. The processor, when loading and executing the one or more instructions, is caused to perform the methods for playing back a live-streaming video according to the embodiments. The first client. includes a processor, a memory, a network interface, a display screen and the like, which are connected via a system bus. The processor is configured to provide computing and control capabilities. The memory includes a non-volatile computer-readable storage medium and an internal memory. The non-volatile computer-readable storage medium stores an operating system, a computer program (which cause the processor to perform the method for playing back a live-streaming video when run by the processor) and a database, The internal memory provides an environment for running the operating system and the computer program in the non-volatile computer-readable storage medium. The database is configured to store data involved in performing the method for playing back a live-streaming video. For example, the database is configured to store target video data and the like. The network interface is configured to communicate with an external terminal via the network. For example, the network interface is configured to send a live-stream playback instruction to the server. The display screen is a liquid crystal display (LCD) screen or an e-ink display screen.

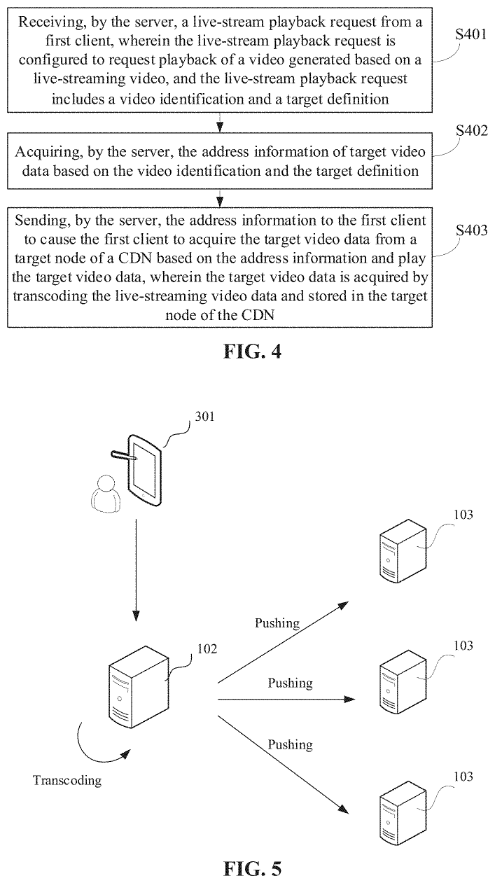

FIG. 4 is a flowchart of a method for playing back a live-streaming video according to an embodiment of the present disclosure. Referring to FIG. 4, the method is performed by a server and includes following processes.

In S401, the server receives a live-stream playback request from a first client, The live-stream playback request is configured to request playback of a video generated based on a live-streaming video, and the live-stream playback request includes a video identification and a target definition.

The first client is a client used by a user watching a live streaming under a live-streaming scenario. That is, the first client is a viewer client. The live-streaming video (also referred to as source live-streaming video) is referred to a video generated by performing live streaming on a live-streaming platform. Generally, the live-streaming video has the highest bit rate, which means the live-streaming video supports a relatively high definition.

After the live streaming is started, in a case that the anchor who posts the live-streaming video (or a viewer watching the video) chooses to make a recording for playback, a second client (or the first client) acquires a playback video by recording the live-streaming video. The second client is an anchor client. In some embodiments, the recorded playback video is stored in a memory space with corresponding address information (for example, the address information is a link address of the memory space where the video is stored). The memory space is a memory of the second client or the server, or a storage space independent. of the server or the second client. For example, the storage space is a video cloud server (also called a video source site or video cloud) configured to manage a video. Taking the video cloud server as an example, the second client (or the first client) uploads video data of the live-streaming video to the video cloud server for storage and management during the recording process.

In some scenarios, the user (viewer) may trigger a process of playing back (also referred to as a playback process) one or some of the playback videos (that is, the target playback video) by the first client. That is, the live-stream playback instruction is generated in the first client. The target video data is referred to data related to the live-streaming video to be played hack, and may be called the target playback video for short in some embodiments of the present disclosure. The live-stream playback instruction further includes a target definition. In a process of playing back a video, the user may select one from a plurality of definitions for playing back the video, wherein the plurality of definitions include blue ray (1080P), ultra-high definition (740P), high definition (480P), standard definition (290P), or the like. In some embodiments, playback video data corresponding to the same live-streaming video are stored in a memory space corresponding to the same address, or stored in memory spaces corresponding to different addresses.

In some embodiments, the first client generates the live-stream playback instruction based on the user's selection, and sends, based on the live-stream playback instruction, the live-stream playback request to the server to request the server to send address information (URL for short) of the target video data.

In S402, the server acquires address information of target video data based on the video identification and the target definition.

The target video data is video data of the live-streaming video with the video identification and the target definition. Video data of different definitions correspond to different address information.

In some embodiments, acquiring, by the server, the address information of the target video data based on the video identification and the target definition includes: determining, by the server and based on the video identification, at least one piece of candidate video data corresponding to the video identification, wherein the at least one piece of candidate video data is generated based on the live-streaming video; selecting the target video data from the at least one piece of candidate video data based on the target definition, and determining the address information of the target video data.

The address information is referred to link address of the memory space where the target video data is stored. In some embodiments, in a case the address information is stored in the server, the server acquires the address information from a local memory; or in a case that the address information is stored in another electronic device such as the video cloud server, the server acquires the address information from another electronic device such as the video cloud server.

In some embodiments, taking an example in which the server acquires the address information from the local memory, the server stores a mapping table between the video data of each definition and the address information. Thus, in response to receiving a live-stream playback request, the server may determine, based on a target solution in the live-stream playback request, the corresponding address information by querying the mapping table in the local memory.

The server stores a mapping table between playback video of each definition of each live-streaming video and video address. In response to receiving the live-stream playback request, the server may determine, based on the video identification and the target definition in the live-stream playback request, the corresponding address information by querying the mapping table in the local memory.

In some embodiments, in some cases, the address information corresponds to an access path, wherein the access path is configured to cause the first client to access the target video data.

in some embodiments, the target video data is stored in the server or in a target node of the CDN. Thus, the address information is the address where the target video data is stored in the server or the address where the target video data is stored in the target node of the CDN.

In some embodiments, the target video data is stored in the target node of the CDN. In response to receiving live-streaming video data from the second client, the server assigns the corresponding target node of the CDN for the live-streaming video data, such that the server can assign address information in the target node of the CDN for the corresponding live-streaming video data (that is, address information of playback video data). In some embodiments, in response to receiving the live-streaming video data, the video cloud server is also able to assign the corresponding target node of the CDN for the live-streaming video data, such that the video cloud server can assign address information in the target node of the CDN for the corresponding live-streaming video data.

In S403, the server sends the address information to the first client to cause the first. client to acquire the target video data from a target node of a CDN based on the address information and play the target video data. The target video data is acquired by transcoding the live-streaming video data and stored in the target node of the CDN.

In some embodiments, the server stores the target video data in the server. Thus, the process S403 is replaced as that the server sends the address information to the first client, the address information is configured to cause the first client to acquire the target video data from the server and play the target video data.

The node of the CDN, which is an intelligent virtual network constructed based on an existing network, relies on edge servers deployed in various locations, and enables users to access the desired content nearby by functional modules of the central platform such as the load balancing, content distributing and scheduling modules, which reduces network congestion and improves the response speed and hit rate of user access. In the embodiments of the present disclosure, the server pre-stores the video data for playback in the node of the CDN, thereby enabling the first client to acquire the target video data from the node of the CDN. Compared to acquiring the target video data from a centralized server or the video cloud server at distance, acquiring the target video data from the node of the CDN is more efficient and can effectively prevent the video playback from lagging. In some embodiments, the node of the CDN may be a node of a CDN provided by Alibaba, Tencent, Netflix, or the like.

In response to receiving the address information from the server, the first client may acquire the target node of the CDN where the target video data is stored, such that the first client can acquire the target video data by accessing the target node of the CDN and play the target video data in an interface, thereby realizing the playback of the live-streaming video.

In some embodiments, one or more pieces of address information may be present. In response to more than one piece of address information, the first client selects, in response to receiving the address information, a piece of address information from the pieces of address information, and acquires the target video data based on the selected address information. In some embodiments, in response to occurrence of a problem in acquiring the target video data based on the selected address information, the first client acquires another piece of address information from the pieces of address information, and acquires the target video data based on the acquired address information.

Selecting, by the first client, one piece of address information from the pieces of address information includes: randomly selecting one piece of address information from the pieces of address information: or selecting one piece of address information nearest to the first client from the pieces of address information, such that the target video data can be acquired nearby, thereby improving the acquisition efficiency.

In the methods for playing back a live-streaming video according to the embodiments, the server transcodes, based on at least one definition, the live-streaming video data of the live-streaming video in advance. Thus, in a case the user needs to play back the live-streaming video, the server can send, based on the target definition of the live-streaming video that the user needs to play back, the target video data corresponding to the target definition to the first client, such that the user can acquire the corresponding video data of the definition based on needs, thereby avoiding a low smoothness of the playing of the video data caused by only acquiring the video data of the highest definition. Therefore, the solution can improve the smoothness of playback of the video data.

In some embodiments, in response to acquiring the address information, the first client directly sends a video acquire request to the target node of the CDN to request the target node of the CDN to send the target video data to the first client. Alternatively, after the first client sends the live-stream playback request to the server, the server directly controls the target node of the CDN to send the target video data to the first client instead of sending the address information of the target video data to the first client, which eliminates the process of acquiring the address information and accessing the target node of the CDN by the client, thereby improving the efficiency of acquiring the target video data.

In some embodiments, before the server receives the live-stream playback request from the first client, the method for playing back a live-streaming video further includes: acquiring, by the server, the live-streaming video data; acquiring at least one piece of candidate video data by transcoding the live-streaming video data based on at least one definition, and pushing the at least one piece of candidate video data to at least one node of the CDN, such that the at least one piece of candidate video data is respectively stored in the at least one node of the CDN.

The server may set a plurality of definitions in advance, and the server may transcode the live-streaming video data based on each of the plurality of definitions, or transcode the. live-streaming video data only based on the at least one definition with a high playback probability. In some embodiments, in the case that the server transcodes live-streaming video data only based on the at least one definition with the high playback probability, determining, by the server, the at least one definition includes followings.

The server determines playback probabilities of the live-streaming video data corresponding to the plurality of definitions, and determines, from the plurality of definitions, at least one definition with the playback probability higher than a predetermined probability threshold.

The at least one node of the CDN includes a target node of the CDN, and the candidate video data includes the target video data. The live-streaming video is referred to the video generated during the live streaming, and the live-streaming video data is referred to information related to live-streaming video. In some embodiments of the present disclosure, the live-streaming video data may be referred to as the live-streaming video for short. The live-streaming video data may be stored in the second client and uploaded to the server by the second client; or the live-streaming video data may be stored in the live-stream source site, and in a case that the live-streaming video data needs to be uploaded to the server, the second client sends a video send instruction to the live-stream source site to cause the live-stream source site to send the corresponding live-streaming video data to the server.

After the live-streaming video data is received, the server transcodes the live-streaming video data based on requirements of different definitions to generate files supporting different definitions (for example, the files as transcoded may support 1080P, 740P, 480P, and the like). Then, the server pushes the files completing the transcoding (that is, the candidate video data generated by transcoding) to the nodes of the CDN for storage.

The server pushes respective candidate video data to the corresponding node of the CDN based on the address information. The server may push each of the at least one piece of candidate video data to one node of the CDN, that is, the candidate video data with different definitions are stored in respective node of the CDN. Or, the server may push the at least one piece of candidate video data to each of the nodes of the CDN, that is, each of the nodes of the CDN stores the candidate video data with at least one definition.

Before the server pushes the at least one piece of candidate video data to the at least. one node of the CDN, the server determines the address information. Determining the address information by the server includes: assigning, by the server, a node of the CDN to the at least one piece of candidate video data; determining the address information of the at least one piece of candidate video data based on the assigned node of the CDN.

In some embodiments, FIG. 5 is a schematic diagram of the process of pushing candidate video data by a server to a node of a CDN according to an embodiment of the present disclosure. As shown in FIG. 5, the second client 301 uploads the live-streaming video data to the server 102; and the server 102 transcodes the live-streaming video data based on different definitions to acquire different candidate video data. Then, the server 102 pushes the candidate video data to each node of the CDN 103 (three nodes of the CDN are shown in FIG. 5, and more or less nodes of the CDN may be included in practical application scenarios). The node of the CDN 103 that receives the candidate video data stores the corresponding candidate video data.

In the embodiment mentioned above, the server transcodes the live-streaming video data into video data with different definitions. The user may select the video data with a high definition in a case that the network has a good state, and select the video data with a low definition in a case that the network has a poor state, thereby fully satisfying different needs of the user. In addition, the server pushes the target video data as transcoded to the nodes of the CDN for storage, such that the first client can acquire the target video data quickly from the CDN, thereby improving the efficiency of acquiring the target video data and the smoothness in playing the target video data.

In some embodiments, the address information may also be generated by the video cloud server. The cooperation between the video cloud server and the server may be implemented as follows. After the server acquires the at least one piece of candidate video data by transcoding the live-streaming video data based on at least one definition, the method for playing back a live-streaming video further includes: acquiring, by the server, address information of the at least one piece of candidate video data from the video cloud server.

The video cloud server is configured to acquire the node of the CDN to which the at least one piece of candidate video data is assigned, determine the address information of the at least one piece of candidate video data based on the node of the CDN as assigned, and store the address information of the at least one piece of candidate video data into a database. Accordingly, acquiring, by the server, the address information of the target video data based on the video identification and the target definition includes: acquiring, by the server, the address information of the target video data from the database based on the video identification and the target definition.

In some embodiments, the candidate video data is similar in concept to the target video data. In the case that one or more pieces of candidate video data correspond to the live-stream playback request, the candidate video data corresponding to the live-stream playback request is the target video data.

In the process of generating the live-streaming video (or after the live-streaming is ended), the second client sends the corresponding live-streaming video data to the video cloud server for storage and management. The video cloud server is implemented by one or more memories.

In some embodiments, the video cloud server may assign the corresponding node of the CDN for the live-streaming video data in response to receiving the live-streaming video data. in some embodiments, the video cloud server assigns, based on a location of a region, the live-streaming video data to the node of the CDN near the target region where the live-streaming video is most likely to be played back, or assigns the live-streaming video data to all of the nodes of the CDN. After the nodes of the CDN are assigned, the video cloud server acquires the address information of the live-streaming video data and sends the address information to the server.

In one or more embodiments, the process of transcoding the live-streaming video data may be implemented by the video cloud server, and after the transcoding is completed, the video cloud server assigns the node of the CDN to the respective candidate video data as transcoded and generates corresponding address information. The video cloud server may also receive the candidate video data that has been transcoded from the server, assign the corresponding node of the CDN to the respective candidate video data (different candidate video data are assigned to the same node of the CDN or different nodes of the CDN) and generate corresponding address information.

In some embodiments, the process that the video cloud server acquires the live-streaming video data/candidate video data, assigns the node of the CON to the respective candidate video data, and determines address information may be adjusted according to the actual situation. In a case that the live-streaming video data is received by the video cloud server, the video cloud server assigns the node of the CDN to the live-streaming video data, and each of the candidate video data is stored in the memory space corresponding to the address information. Thus, when the video cloud server determines the address information of the target video data, the video cloud server takes the address information of the live-streaming video data as the address information of the target video data. In a case that the candidate video data is received by the video cloud server, the video cloud server assigns the node of the CDN to the respective candidate video data separately. Thus, when the video cloud server determines the address information of the target video data, the video cloud server takes the address information corresponding to the candidate video data as the address information of the target video data.

In some embodiments, the server stores the address information from the video cloud server into a database; determines, upon receiving the live-stream playback request from the first client, the target video data corresponding to the live-stream playback request; determines definition selection information corresponding to the target video data; queries, based on the definition selection information, corresponding address information from the database; and sends the address information as the address information of the target video data to the first client. In this way, the server can quickly find the address information via the local database without accessing the video cloud server each time for acquiring the address information, such that the efficiency of acquiring the address information is effectively improved, thereby reducing the waiting time of the first client to play back the live-streaming video, improving the efficiency of playback of the video.

In some embodiments, pushing, by the server, the at least one piece of candidate video data to the at least one node of the CDN includes: determining, by the server, the playback probability of the respective candidate video data, and pushing the candidate video data with the playback probability higher than a first predetermined probability threshold to the at east one node of the CDN.

The playback probability is referred to a probability that the viewer plays back a piece of live-streaming video data. The server may determine the playback probability of the respective candidate video by prediction. Various ways may be adopted to predict the playback probabilities. For example, the server may determine the playback probabilities based on the number of followers of a target anchor, play attention degree of the source live-streaming video during the live streaming (the play attention degree is determined based on the number of viewers during the live streaming and indicates popularity), attention degree of the category to which the source live-streaming video belongs (for example, in a case that the source live-streaming video is an apple-related video (Chinese pronunciation of apple has a meaning of peace and safe), the server may determine that the corresponding candidate video data has a high attention degree when the Christmas Eve is approaching). The target anchor is referred to an anchor who posts the source live-streaming video corresponding to the target video data, that is, the target anchor is referred to a web account of an anchor on the live-streaming platform.

The number of followers will be taken as an example to illustrate the process of determining the playback probabilities. In some embodiments, the server acquires the number of followers of the target anchor who posts the live-streaming video data, and predicts the playback probability of the respective candidate video data based on the number of followers.

The followers of the target anchor are referred to users who have followed the web account of the target anchor or have watched live-streaming videos of the target anchor, The at least one piece of candidate video data in the embodiments of the present disclosure is referred to the candidate video data of different definitions as acquired by transcoding the same live-streaming video data.

In some embodiments, the server may predict the playback probability of the respective candidate video data based on the number of followers in at least following embodiments. In a first embodiment, the server determines a probability that the users play back the video of the target anchor based on the overall number of followers of the target anchor, and determines the probability as the playback probabilities of all the candidate video data. In a second embodiment, the server determines the number of users watching the source live-streaming video, determines the number of users as the number of followers, and determines, a probability that the users play back the source live-streaming video based on the number of followers. Meanwhile, the server also analyzes the probability that the users watch the respective candidate video data, and finally determines the playback probability that the users play back the respective candidate video data based on the probability that the users play back the source live-streaming video and the probability that the users watch the respective candidate video data. In a third embodiment, the server determines the number of users watching the source live-streaming video, determines the number of users as the number of followers, determines the definitions chosen by the users when watching the streaming, determines a proportion of each of the definitions to be watched based on the number of users corresponding to each of the definitions, and determines the playback probability of the respective candidate video data based on the number of followers and the proportions.

In some embodiments, in the case that the playback probabilities of the candidate video data depends on the playback probability of the live-streaming video (for example, the playback probabilities of the candidate video data are the playback probabilities determined according to the first embodiment), candidate video data corresponding to the same live-streaming video may all be pushed to one or more nodes of the CDN if the playback probability is higher than the first predetermined probability threshold.

In some embodiments, the first predetermined probability threshold may be determined based on the actual circumstances. For example, the first predetermined probability threshold is 80%, 90%, or the like.

According to the aforesaid embodiments, some determinations may be made before the video is pushed. The server determines the probability that the current playback video is played. In a case that the probability is not lower than a second predetermined probability threshold, the playback video is pushed to the node of the CDN in advance; and in a case that the probability is lower than the second predetermined probability threshold, the playback video is not pushed to the node of the CDN in advance (or the candidate video data with the low probability is only pushed after pushing of the candidate video data with the high playback probability is completed). Thus, the operating pressure of the CDN can be reduced under a premise of meeting the user's playback demand, thereby ensuring the smooth operation of the whole system.

The second predetermined probability threshold may be determined based on the actual situation, and may be the same as or different from the first predetermined probability threshold, which is not specifically limited in the embodiments of the present disclosure.

In some embodiments, acquiring, by the server, the live-streaming video data includes: receiving, by the server, a video generation request from the second client, verifying the video generation request, and acquiring the live-streaming video data in response to a successful verification.

The anchor determines whether to generate a live-streaming video for playback during or after the live streaming, and in a case that the live-streaming video for playback is generated, other users can watch the live-streaming video, that is, the playback of the live-streaming video is achieved. The anchor triggers the video generation request via a control on the second client, and the video generation request includes an anchor identification and description information of the live-streaming video. After the video generation request is received, the server verifies the video generation request based on the anchor identification and the description information of the live-streaming video, and acquires the live-streaming video data in response to a successful verification. In a case that the verification is unsuccessful, the live-streaming video data is not acquired.

For example, the server determines whether the anchor has a permission to generate a live-streaming video for playback based on the anchor identification, and determines whether content of the live-streaming video meets a requirement (e.g., whether the content conforms to public order and morality) based on the description information of the live-streaming video. The verification is determined to be successful in response to determining that the anchor has the permission to generate the live-streaming video for playback and the content of the live-streaming video meets the requirement. The verification is determined to be unsuccessful in response to determining that the anchor does not have the permission to generate the live-streaming video for playback or the content of the live-streaming video does not meet the requirement,

In many cases, the anchor may select to generate the playback video (or the anchor may select “generate a live-streaming video for playback each time” on the live-streaming platform). In this case, the second client may automatically send a video generation request to the server during or after the live streaming, and manual operation from the anchor is unnecessary. For example, the second client automatically sends the playback video generation request to the server when the target anchor starts the live streaming or performs the live streaming for a specific length of time. In this way, the anchor's operation can be effectively reduced, thereby improving the user experience.

In the case that the verification is successful, the server acquires the corresponding live-streaming video data from the video cloud server, and performs the process of transcoding videos.

In some embodiments, acquiring, by the server, the live-streaming video data includes: receiving, by the server, a video generation request from the second client; verifying the video generation request; in response to the successful verification, sending a video generation token to the second client, wherein the video generation token is configured to cause the second client to trigger the video cloud server to upload the live-streaming video data to the server; and receiving the live-streaming video data uploaded by the video cloud server. The live-streaming data in the video cloud server is uploaded by the second client during the recording process.

The video generation token is a message instructing the start of the playback recording. The second client may start the recording of the live-streaming video in response to receiving the video generation token.

In some embodiments, in the case that the live-streaming video data is stored in the video cloud server, the server directly acquires the live-streaming video data from the video cloud server in response to the successful verification of the video generation request. In the case that the live-streaming video data is stored in the second client, the second client uploads the live-streaming video data to the server and uploads the live-streaming video data to the video cloud server at the same time.

In the embodiments, in response to receiving the video generation request, the server verifies the video generation request, and the second client is allowed to upload the live:-streaming video data only in response to the successful verification, such that the quality of the playback video data can be effectively ensured and the environment of the live streaming platform can be effectively purified.

In some embodiments, the server 102 is implemented by a plurality of servers. For example, the server is implemented by a live server and an application server. The live server is configured to control information related to the live streaming, and the application server is configured to interact with the first client, the second client, and the like. in addition, the server 102 provides an application programming interface (API) to the outside, wherein the API is configured to perform data interaction with external electronic devices. In some embodiments, the application server receives, by the API, a video acquisition instruction from the first client, and then requests the playback video data of the target anchor from the live server. The live server reads memcached data from the database to acquire the playback video data (also called playback view) of the target anchor, and sends the playback video data to the application server. Then, the application server maps the playback video data to generate a video playback list, and sends the video playback list to the first client.

In some embodiments, the server 102 implements each of functions by the consumer, which is a monitor tool, For example: (1) in a case that the server 102 downloads the live-streaming video data from the video cloud server, transcodes the live-streaming data, and stores the live-streaming video data as transcoded in the database, the consumer may monitor the process of downloading and transcoding the live-streaming video data in real time. (2) The consumer monitors the situation of the server 102 acquiring the address information from the video cloud server in real time. (3) The consumer monitors the situation of pushing the candidate video data to the nodes of the CDN in real time, wherein pushing the candidate video data to the nodes of the CDN may also be called warmup. (4) The consumer monitors situation of generating the video playback list in real time, and updates the video playback list of the anchor at the same time. (5) In a case that each playback video has a corresponding photo ID after the video playback list is generated, the consumer can monitor the photo ID stored in the database.

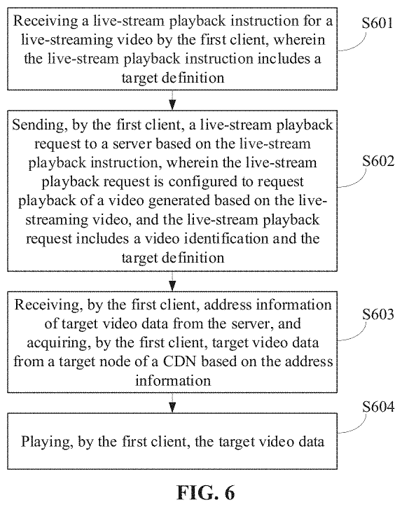

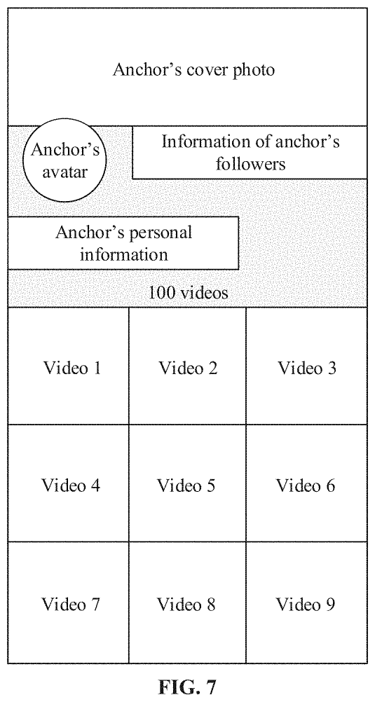

FIG. 6 is a flowchart of a method for playing back a live-streaming video according to an embodiment of the present disclosure. The method is performed by the first client and includes following processes as shown in FIG. 6.

In S601, the first client receives a live-stream playback instruction for a live-streaming video, wherein the live-stream playback instruction includes a target definition.

In S602, the first client sends a live-stream playback request to a server in response to the live-stream playback instruction. The live-stream playback request is configured to request playback of a video generated based on the live-streaming video, and the live-steam playback request includes a video identification and the target definition.

In S603, the first client receives address information of target video data from the server, and acquires target video data from a target node of a CDN based on the address information.

The target video data is referred to video data of the live-streaming video with the video identification and the target definition. In addition, the target video data is acquired by transcoding live-streaming video data and stored in the target node of the CDN. The video data of different definitions correspond to different address information.

In some embodiments, in response to the address information being address information in the target node of the CDN, the first client acquires the target video data from the target node of the CDN based on the address information; and in response to the address information being address information in the server, the first client acquires the target video data from the server based on the address information.

In S604, the first client plays the target video data.

in the method for playing back a live-streaming video according to the aforesaid embodiments, the live-streaming video data is transcoded and stored in the node of the CDN in advance. In a case that the user needs to play back the video, the first client sends the live-stream playback request including the definition selection information to the server to acquire the corresponding address information, Thus, the first client can quickly acquire, from the target node of the CDN, the target video data based on the address information and play the target video data, such that the quick acquisition and play of the target video data can be ensured, and the problem that the user experiences lag while playing back the video for the first time can be avoided.

In some embodiments, receiving, by the first client, the live-stream playback instruction for the live-streaming video includes: displaying at least one definition of the live-streaming video, and receiving the live-stream playback instruction for target definition among the at least one definition.

Before the first client receives the live-stream playback instruction for the live-streaming video, the method for playing back a live-streaming video further includes: receiving, by the first client, a video acquisition instruction, wherein the video acquisition instruction includes an anchor identification; acquiring, from the server, a video playback list corresponding to the anchor identification; displaying the video playback list; and acquiring a selected video identification in the video playback list. In some embodiments, the anchor identification is identification information of the anchor who posts the live-streaming video data.

The video acquisition instruction is an instruction triggered when a user taps/clicks on a homepage of the target anchor, or an instruction triggered when a user taps/clicks on the “watch video” control in the homepage of the target anchor. In response to receiving the video acquisition instruction, the first client acquires, from the server, a video generated by the target anchor, and each video corresponds to a thumbnail photo. In addition, each thumbnail photo has a corresponding photo ID. Then, the first client generates the video playback list of the target anchor (the list may carry the thumbnail photo of each video for the viewer to make selection).

FIG. 7 is a schematic diagram of an interface for a video playback list according to an embodiment of the present disclosure, As shown in FIG, 7, the interface shows information related to the anchor (cover photo, anchor's avatar, follower information, personal information, and the like) and recorded videos (such as the nine videos in FIG. 7). In some embodiments, the first client may directly receive and display the video playback list from the server.

In the aforesaid embodiments, the viewer may tap or click on one of the icons in the interface. At this point, the first client receives the live-stream playback instruction and starts the process of acquiring the target video data from the server, which can facilitate the viewer's video selection and improve the convenience in viewing videos.

In some embodiments, the first client may see bullet subtitles (also referred to as barrages) sent by itself or others during the live streaming or playback process. The process is implemented as follows. During the process of playing the target video data by the first client, the first client pulls bullet subtitle information from the live server via the API to display the bullet subtitle information. Meanwhile, the first client stores the information as pulled in a cache or database, such that when a user wants to play the target video data again, the first client can directly acquire the bullet subtitle information from the cache or database, which eliminates the need to repeatedly pull the bullet subtitle information from the live server.

In some embodiments, the first client may perform operations such as like and comment. The process is implemented as follows. The first client sends operation information of the like and comment to the application server, and the application server stores and controls the first client to display the corresponding like and comment information in the interface.

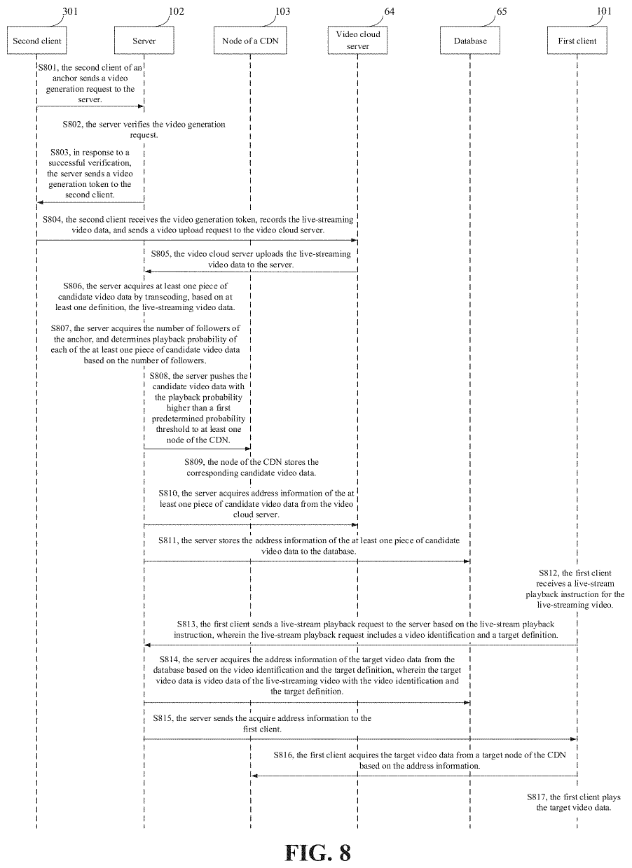

FIG. 8 is a time sequence chart of a method for playing back a live-streaming video according to an embodiment of the present disclosure. Referring to FIG. 8, the method relates to a second client 301, a server 102, a node of a CDN 103, a video cloud server 64, a database 65, and a first client 101, and includes following processes.

in S801, the second client of an anchor sends a video generation request to the server.

In S802, the server verifies the video generation request.

In S803, the server sends a video generation token to the second client in response to a successful verification.

In S804, the second client receives the video generation token, records the live-streaming video data, and sends a video upload request to the video cloud server.

In S805, the video cloud server uploads the live-streaming video data to the server.

In S806, the server acquires at least one piece of candidate video data by transcoding, based on at least one definition, the live-streaming video data.

In S807, the server acquires the number of followers of the anchor, and determines playback probability of each of the at least one piece of candidate video data based on the number of followers.

In S808, the server pushes the candidate video data with the playback probability higher than a first predetermined probability threshold to at least one node of the CDN.

In S809, the node of the CDN stores the corresponding candidate video data.

In S810, the server acquires address information of the at least one piece of candidate video data from the video cloud server.

In S811, the server stores the address information of the at least one piece of candidate video data to the database.

In S812, the first client receives a live-stream playback instruction for the live-streaming video.

In S813, the first client sends a live-stream playback request to the server in response to the live-stream playback instruction, wherein the live-stream playback request includes a video identification and a target definition.

In S814, the server acquires the address information of the target video data from the database based on the video identification and the target definition. The target video data is video data of the live-streaming video with the video identification and the target definition.

In S815, the server sends the acquired address information to the first client.

In S816, the first client acquires the target video data from a target node of the CDN based on the address information.

In S817, the first client plays the target video data.

In the method for playing back a live-streaming video according to the aforesaid embodiments, the live-streaming video data is transcoded and stored in the node of the CDN in advance. In a case that the user needs to play back the video, the first client sends the live-stream playback request including definition selection information to the server to acquire the corresponding address information. Thus, the first client can quickly acquire and play the target video data from the target node of the CDN based on the address information, which can ensure the quick acquisition and play of the target video data, and prevent the user from experiencing lag while playing back the video for the first time.

FIG. 9 is a block diagram of an apparatus 900 for playing back a live-streaming video according to an embodiment of the present disclosure. The apparatus 900 is applied to a server. Referring to FIG. 9, the apparatus 900 includes a request receiving unit 901, an address information acquiring unit 902, and an address information returning unit 903.

The request receiving unit 901 is configured to receive a live-stream playback request from a first client. The live-stream playback request is configured to request playback of a video generated based on the live-streaming video, the live-stream playback request includes a video identification and a target definition, and the first client is a viewer client.

The address information acquiring unit 902 is configured to acquire address information of target video data based on the video identification and the target definition. The target video data is video data of the live-streaming video with the video identification and the target definition.

The address information returning unit 903 is configured to send the address information to the first client. The address information is provided to the first client to acquire the target video data and play the target video data.

With the apparatus for playing back a live-streaming video according to the embodiments, the server can transcode the live-streaming video data of the live-streaming video in advance based on at least one definition. In a case that the user needs to play back the live-streaming video, the server can send, based on the target definition of the live-streaming video that the user needs to play back, the target video data corresponding to the target definition to the first client, such that the user can acquire the video data of the corresponding definition based on his/her needs. In this way, the problem of low smoothness of the play of the video data which is caused by only acquiring the video data of the highest definition can be avoided, Therefore, this solution can improve the smoothness of the play of the video data.

In some embodiments, the address information is address information of the target video data in a target node of a CDN; and the target video data is acquired by transcoding live-streaming video data and stored in the target node of the CDN.

In some embodiments, the apparatus for playing back a live-streaming video further includes a live-streaming video receiving unit, a video transcoding unit and a video pushing unit. The live-streaming video receiving unit is configured to acquire live-streaming video data. The video transcoding unit is configured to acquire at least one piece of candidate video data by transcoding the live-streaming video data based on at least one definition. The video pushing unit is configured to push the at least one piece of candidate video data to the target node of the CDN. The at least one piece of candidate video data is stored in the target node of the CDN, and the candidate video data includes the target video data.

In some embodiments, the live-streaming video receiving unit is configured to receive a video generation request from a second client, wherein the second client is an anchor client; verify the video generation request; and acquire the live-streaming video data in response to a successful verification.

In some embodiments, the video generation request includes an anchor identification and description information of the live-streaming video. The live-streaming video receiving unit is configured to determine whether the anchor has a permission to generate a live-streaming video for playback based on the anchor identification; determine whether content of the live-streaming video meets a requirement based on the description information of the live-streaming video; and determine that the verification is successful in response to determining that the anchor has the permission to generate the live-streaming video for playback and the content of the live-streaming video meets the requirement.

In some embodiments, the live-streaming video receiving unit is configured to send a video generation token to the second client in response to the successful verification; and receive the live-streaming video data uploaded by the video cloud server. The video generation token is configured to cause the second client to trigger a video cloud server to upload the live-streaming video data to the server. The live-streaming data in the video cloud server is uploaded by the second client in a recording process.

In some embodiments, the video pushing unit includes a probability predicting subunit and a video pushing subunit. The probability predicting subunit is configured to determine a playback probability of each of the at least one piece of candidate video data. The video pushing subunit is configured to push the candidate video data with the playback probability higher than a predetermined probability threshold to the target node of the CDN.

In some embodiments, the apparatus for playing back a live-streaming video further includes a network node assigning unit and an address determining unit. The network node assigning unit is configured to assign a node of the CDN for the at least one piece of candidate video data. The address determining unit is configured to determine address information for the at least one piece of candidate video data based on the assigned node of the CDN.

In some embodiments, the video transcoding unit is further configured to determine playback probabilities of live-streaming video data corresponding to a plurality of definitions, and determine, from the plurality of definitions, at least one definition with the playback probability higher than a predetermined probability threshold.

In some embodiments, the address information acquiring unit 902 is configured to determine, based on the video identification, at least one piece of candidate video data corresponding to the video identification, selects the target video data from the at least one piece of candidate video data based on the target definition, and determines the address information of the target video data. The at least one piece of candidate video data is generated based on the live-streaming video.

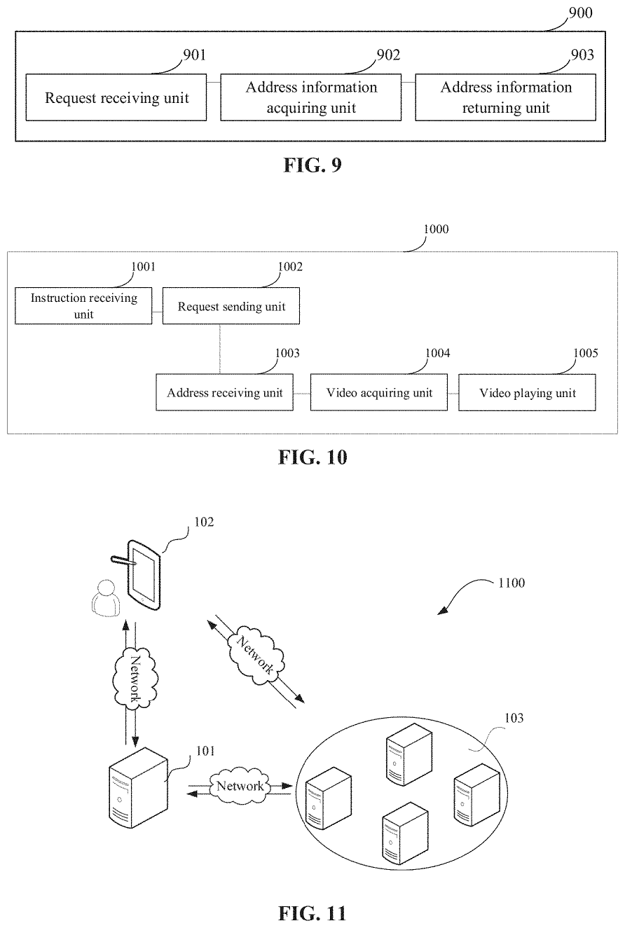

FIG. 10 is a block diagram of an apparatus 1000 for playing back a live-streaming video according to an embodiment of the present disclosure. The apparatus 1000 is applied to a first client. Referring to FIG, 10, the apparatus 1000 includes an instruction receiving unit 1001, a request sending unit 1002, an address receiving unit 1003, a video acquiring unit 1004 and a video playing unit 1005.

The instruction receiving unit 1001 is configured to receive a live-stream playback instruction for a live-streaming video. The live-stream playback instruction includes a target. definition.

The request sending unit 1002 is configured to send a live-stream playback request to a server in response to the live-stream playback instruction. The live-stream playback request is configured to request playback of a video generated based on the live-streaming video, and the live-stream playback request includes a video identification and the target definition.

The address receiving unit 1003 is configured to receive address information of target video data from the server. The target video data is video data of the live-streaming video with the video identification and the target definition.

The video acquiring unit 1004 is configured to acquire the target video data based on the address information.

The video playing unit 1005 is configured to play the target video data.

With the apparatus for playing back a live-streaming video according to the aforesaid embodiments, the live-streaming video data is transcoded and stored in the node of the CDN in advance. In a case that the user needs to play back the video, the first client sends the live-stream playback request including definition selection information to the server to acquire corresponding address information. Thus, the first client can quickly acquire and play the target video data from the target node of the CDN based on the address information, such that the quick acquisition and play of the target video data can be ensured, and the user experiencing lag while playing back the video for the first time can be avoided.

In some embodiments, the video acquiring unit 1004 is configured to acquire the target video data from a target node of a CDN based on the address information. The target video data is acquired by transcoding live-streaming video data and stored in the target node of the CDN.

In some embodiments, the instruction receiving unit 1001 is configured to display least one definition of the live-streaming video, and receive the live-stream playback instruction for the target definition among the at least one definition.

In some embodiments, the apparatus further includes an acquisition instruction receiving unit, a list acquiring unit and a list displaying unit. The acquisition instruction receiving unit is configured to receive a video acquisition instruction, wherein the video acquisition instruction includes an anchor identification. The list acquiring unit is configured to acquire a video playback list corresponding to the anchor identification from the server. The list displaying unit is configured to display the video playback list. The video acquiring unit 1004 is further configured to acquire a selected video identification in the video playback list.

in some embodiments, a plurality of pieces of the address information are provided. The video acquiring unit 1004 is configured to select a piece of address information from the pieces of address information; acquire the target video data based on the selected address information; and in response to occurrence of a problem in acquiring the target video data based on the selected address information, acquire another piece of address information from the pieces of address information, and acquire the target video data based on the acquired address information.

With regard to the component in the aforesaid embodiments, the specific manner in which the respective modules perform the operations has been described in detail in the method embodiments, and will not be explained in detail herein.

FIG. 11 is a block diagram of a system 1100 for playing back a live-streaming video according to an embodiment of the present disclosure. As shown in FIG. 11, the system includes a server 102, a first client 101, and at east one node of a CDN 103, which are connected with each other over the network.

The at least one node of the CDN is configured to store playback video data as transcoded from live-streaming video data. The first client 101 is configured to receive a live-stream playback instruction for the live-streaming video, and send a live-stream playback request to the server in response to the live-stream playback instruction. The live-stream playback instruction includes a target definition. The live-stream playback request is configured to request playback of a video generated based on the live-streaming video, and the live-stream playback request includes a video identification and the target definition.

The server 102 is configured to receive the live-stream playback request from the first client, acquire address information of target video data based on the video identification and the target definition, and send the address information to the first client. The target video data is video data of the live-streaming video with the video identification and the target definition.

The first client 101 is further configured to acquire the target video data from a target node of the CDN of the at least one node of the CDN based on the address information, and play the target video data. The target video data is acquired by transcoding live-streaming video data and stored in the target node of the CDN.

In the system for playing back a live-streaming video according to the aforesaid embodiments, the live-streaming video data is transcoded and stored in the node of the CDN in advance. In a case that the user needs to play back the video, the first client sends the live-stream playback request including definition selection information to the server, and the server acquires the corresponding address information based on the live-stream playback request. Thus, the first client can quickly acquire and play the target video data from the target node of the CDN based on the address information, such that the quick acquisition and play of the target video data can be ensured, and the user experiencing lag while playing back the video for the first time can be avoided.

In some embodiments, the system 1100 for playing back a live-streaming video further includes a monitor server. The monitor server is configured to monitor the live streaming process and make repairs or notify the operation and maintenance staff in a case that anomaly occurs.

In some embodiments, the first client may perform a report operation. The first client sends report information to the application server via the API, the application server sends the report information to the monitor server via the, API, and then, the monitor server processes the report information.

In sonic embodiments, a non-volatile computer-readable storage medium storing one or more instructions therein is provided. The one or more instructions, when loaded and executed by a processor of a server, cause the server to perform the method for playing back a live-streaming video as applied in the server.

In some embodiments, a non-volatile computer-readable storage medium storing one or more instructions therein is provided. The one or more instructions, when loaded and executed by a processor of a first client, cause the first client to perform the method for playing back a live-streaming video as applied in the first client.

A person of ordinary skill in the art may understand that. all or part of the procedure to perform the method according to the embodiments is capable of being accomplished by a computer program instructing the relevant hardware, and the program may be stored in a non-volatile computer-readable storage medium and sold or employed as a stand-alone product. Embodiments (as a non-exhaustive list.) of the non-volatile computer-readable storage medium include: a power connection portion (electronic device) having one or more routing, a portable computer disk cartridge (magnetic device), a random access memory (RAM), a read-only memory (ROM), an erasable programmable read-only memory (EPROM or flash memory), an optical fiber device, and a compact disc read-only memory (CDROM). Alternatively, the computer-readable medium may even be paper or other suitable medium on which the program can be printed. The program may be acquired electronically by optical scanning of the paper or the other medium which is followed by editing, decoding or processed in other suitable ways if necessary. Then, the program is stored in a memory of a computer.

It should be understood that the various portions of the present disclosure can be implemented with hardware, software, firmware, or a combination thereof. In the embodiments, a plurality of processes or methods are implemented with software or firmware, wherein the software or firmware is stored in memory and executed by a suitable instruction execution system. For example, in the case of being implemented in hardware, the processes or methods may be implemented, as in another embodiment, with any of the following well known techniques or a combination thereof, such as a discrete logic circuit with a logic gate for implementing a logic function on data signals, a specialized integrated circuit with a suitable combination of logic gates, a programmable gate array (PGA), a field programmable gate array (FPGA), and the like.

What is claimed is:

1. A method for playing back a live-streaming video, performed by a server, the method comprising:
receiving a live-stream playback request from a first client, wherein the live-stream playback request is configured to request playback of a video generated based on a live-streaming video, the live-stream playback request comprises a video identification and a target definition, and the first client is a viewer client;
acquiring address information of target video data based on the video identification and the target definition, wherein the target video data is video data of the live-streaming video with the video identification and the target definition; and
sending the address information to the first client, wherein the address information is provided to the first client to acquire the target video data and play the target video data.

2. The method according to claim 1, wherein the address information is address information of the target video data in a target node of a content delivery network; the target video data is acquired by transcoding live-streaming video data and stored in the target node of the content delivery network; and the method further comprises:
acquiring the live-streaming video data;
acquiring at least one piece of candidate video data by transcoding the live-streaming video data based on at least one definition; and
pushing the at least one piece of candidate video data to the target node of the content delivery network, wherein the at least one piece of candidate video data is stored in the target node of the content delivery network, and the candidate video data comprises the target video data.

3. The method according to claim 2, wherein said acquiring the live-streaming video data comprises:
receiving a video generation request from a second client, wherein the second client is an anchor client;
verifying the video generation request; and
acquiring the live-streaming video data in response to a successful verification.

4. The method according to claim 3, wherein the video generation request comprises an anchor identification and description information of the live-streaming video; and
said verifying the video generation request comprises:
determining whether art anchor has a permission to generate a live-streaming video for playback based on the anchor identification;
determining whether content of the live-streaming video meets a requirement based on the description information of the live-streaming video; and.
determining that a verification is successful in response to determining that the anchor has the permission to generate the live-streaming video for playback and the content of the live-streaming video meets the requirement.

5. The method according to claim 3, wherein said acquiring the live-streaming video data in response to the successful verification comprises:
sending a video generation token to the second client in response to the successful verification, wherein the video generation token is configured to cause the second client to trigger a video cloud server to upload the live-streaming video data to the server, the live-streaming video data in the video cloud server being uploaded by the second client in a recording process; and.
receiving the live-streaming video data uploaded by the video cloud server

6. The method according to claim 2, wherein said determining the at least one definition comprises:
determining playback probabilities of live-streaming video data corresponding to a plurality of definitions; and
determining, from the plurality of definitions, at least one definition with a playback probability higher than a predetermined probability threshold.

7. The method according to claim 2, further comprising:
assigning a node of the content delivery network to the at least one piece of candidate video data; and
determining address information of the at least one piece of candidate video data based on the assigned node of the content delivery network.

8. The method according to claim 1, wherein said acquiring the address information of the target video data based on the video identification and the target definition comprises:
determining, based on the video identification, at least one piece of candidate video data corresponding to the video identification, wherein the at least one piece of candidate video data is generated based on the live-streaming video;
selecting the target video data from the at least one piece of candidate video data based on the target definition; and
determining the address information of the target video data.

9. A method for playing back a live-streaming video, performed by a first client, the method comprising:
receiving a live-stream playback instruction for a live-streaming video, wherein the live-stream playback instruction comprises a target definition;
sending a live-stream playback request to a server in response to the live-stream playback instruction, wherein the live-stream playback request is configured to request playback of a video generated based on the live-streaming video, and the live-stream playback request comprises a video identification and the target definition;
receiving address information of target video data from the server, wherein the target video data is video data of the live-streaming video with the video identification and the target definition;
acquiring the target video data based on the address information; and
playing the target video data.

10. The method according to claim 9, wherein said acquiring the target video data based on the address information comprises:
acquiring the target video data from a target node of a content delivery network based on the address information, wherein the target video data is acquired by transcoding live-streaming video data and stored in the target node of the content delivery network.

11. The method according to claim 9, wherein said receiving the live-stream playback instruction of the live-streaming video comprises:
displaying at least one definition of the live-streaming video; and
receiving the live-stream playback instruction for the target definition among the at least one definition.

12. The method according to claim 9, further comprising:
receiving a video acquisition instruction, wherein the video acquisition instruction comprises an anchor identification;
acquiring a video playback list corresponding to the anchor identification from the server;
displaying the video playback list; and
acquiring a selected video identification in the video playback list.

13. The method according to claim 9, wherein a plurality of pieces of the address information are provided; and
said acquiring the target video data based on the address information comprises:
selecting a piece of address information from the pieces of address information;
acquiring the target video data based on the selected address information; and
in response to occurrence of a problem in acquiring the target video data based on the selected address information, acquiring another piece of address information from the pieces of address information, and acquiring the target video data based on the acquired address information.

14. A server, comprising:
a processor; and
a memory configured to store one or more instructions executable by the processor;
wherein the processor, when loading and executing the one or more instructions, is caused to:
receive a live-stream playback request from a first client, wherein the live-stream playback request is configured to request playback of a video generated based on a live-streaming video, the live-stream playback request comprises a video identification and a target definition, and the first client is a viewer client;
acquire address information of target video data based on the video identification and the target definition, wherein the target video data is video data of the live-streaming video with the video identification and the target definition; and
send the address information to the first client, wherein the address information is provided to the first client to acquire the target video data and play the target video data.

15. The server according to claim 14, wherein the address information is address information of the target video data in a target node of a content delivery network; the target video data is acquired by transcoding live-streaming video data and stored in the target node of the content delivery network; and the processor, when loading and executing the one or more instructions, is caused to:
acquire the live-streaming video data;
acquire at least one piece of candidate video data by transcoding the live-streaming video data based on at least one definition; and
push the at least one piece of candidate video data to the target node of the content delivery network, wherein the at least one piece of candidate video data is stored in the target node of the content delivery network, and the candidate video data comprises the target video data.

16. The server according to claim 15, wherein the processor, when loading and executing the one or more instructions, is caused to:
receive a video generation request from a second client, wherein the second client is an anchor client;
verify the video generation request; and
acquire the live-streaming video data in response to a successful verification.

17. The server according to claim 16, wherein the video generation request comprises an anchor identification and description information of the live-streaming video; and the processor, when loading and executing the one or more instructions, is caused to:
determine whether an anchor has a permission to generate a live-streaming video for playback based on the anchor identification;
determine whether content of the live-streaming video meets a requirement based on the description information of the live-streaming video; and
determine that a verification is successful in response to determining that the anchor has the permission to generate the live-streaming video for playback and the content of the live-streaming video meets the requirement.

18. The server according to claim 16, wherein the processor, when loading and executing the one or more instructions, is caused to:
send a video generation token to the second client in response to the successful verification, wherein the video generation token is configured to cause the second client to trigger a video cloud server to upload the live-streaming video data to the server, the live-streaming video data in the video cloud server being uploaded by the second client in a recording process; and
receive the live-streaming video data uploaded by the video cloud server.

19. The server according to claim 15, wherein the processor, when loading and executing the one or more instructions, is caused to:
determine playback probabilities of live-streaming video data corresponding to a plurality of definitions; and
determine, from the plurality of definitions, at least one definition with a playback probability higher than a predetermined probability threshold.

20. The server according to claim 14, wherein the processor, when loading and executing the one or more instructions, is caused to:
determine, based on the video identification, at least one piece of candidate video data corresponding to the video identification, wherein the at least one piece of candidate video data is generated based on the live-streaming video;
select the target video data from the at least one piece of candidate video data based on the target definition; and
determine the address information of the target video data.
